(19) United States
(12) Patent Application Publication
(10) Pub. No.: US 2024/0121540 A1
(43) Pub. Date: Apr. 11, 2024

(54) MAGNETICALLY ATTRACTABLE SHORT-RANGE WIRELESS PERSONAL AREA NETWORK SPEAKTER

(71) Applicant: DCONNECT GROUP LLC, St. Clair, MI (US)

(72) Inventors: Dan Cass, St. Clair, MI (US); Xiaomin Zhu, Shenzhen (CN)

(21) Appl. No.: 18/382,241

(22) Filed: Oct. 20, 2023

Related U.S. Application Data
(63) Continuation-in-part of application No. 18/198,069, filed on May 16, 2023.
Application No. 18/198,069 is a continuation of application No. 17/450,462, filed on Oct. 10, 2021.

(30) Foreign Application Priority Data
Jun. 17, 2021 (CN) 202121349447.1

(51) Int. Cl. H04R 1/02; H04W 4/80

(52) U.S. Cl. CPC H04R 1/021; H04R 1/026; H04R 1/028; H04W 4/80; H04R 2420/07

(57) ABSTRACT

There is disclosed a magnetically attractable short-range wireless personal area network speaker. In an embodiment, the speaker includes a loudspeaker, a control circuit board electrically connected to the loudspeaker, a battery, a speaker housing that includes a speaker body, a speaker bottom plate and a limiting part, and a magnet, as well as a microphone and/or a wireless charger. The limiting part may include an upper cavity at a bottom of the speaker body and a lower cavity at the bottom plate, and the magnet may be fixed the limiting part, outside a magnetic circuit range of the loudspeaker. The wireless charger may include a power pick-up unit (wireless charging receiving coil(s)), which may be disposed in the bottom plate, and a communications and control unit (a wireless charging receiving circuit board electrically connected to the battery and configured to regulate power to charge the battery). Other embodiments are also disclosed.

### CROSS-REFERENCE TO RELATED APPLICATION

This patent application is a continuation-in-part of pending prior U.S. patent application Ser. No. 18/108,069, filed Feb. 10, 2023, entitled “MAGNETICALLY ATTRACTABLE BLUETOOTH SPEAKER,” which in turn is a continuation of pending prior U.S. patent application Ser. No. 17/450,462, filed Oct. 10, 2021, entitled “MAGNETICALLY ATTRACTABLE BLUETOOTH SPEAKER,” which in turn claims priority and benefit of Chinese patent application number 202121349447.1, filed on Jun. 17, 2021, the disclosures of which are incorporated herein by reference.

### TECHNICAL FIELD

This disclosure relates to the technical field of short-range wireless personal area network (WPAN) (e.g., BLUETOOTH) speakers, and more particularly relates to magnetically attractable WPAN speaker.

### BACKGROUND

Generally, as users have increasingly higher requirements for the quality and experience of outdoor fitness and entertainment activities, short-range wireless personal area network (WPAN) (e.g., BLUETOOTH) speakers are becoming more and more popular. WPAN speakers offer a more convenient way to listen to music, particularly on mobile devices such as smartphones and laptops. These portable speakers come in a wide range of sizes, shapes and designs to fit the various needs of users. Users can play different kinds of audio through a WPAN speaker anywhere to create a better atmosphere. With existing WPAN speaker products, although people can easily connect to the WPAN speaker to play audio, they generally can only be placed on, by way of example a tabletop or similar platform, and cannot be attached to the wall or placed upside down, making the WPAN speaker poorly flexible in different usage scenarios and unable to be placed at will, resulting in unsatisfactory user experience.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter. In an embodiment, there is provided a magnetically attractable short-range wireless personal area network (WPAN) (e.g., BLUETOOTH) speaker, which includes a speaker housing, a loudspeaker, a control circuit board, and a magnet. The loudspeaker is electrically connected to the control circuit board. The speaker housing may include a limiting part for securing the magnet, the magnet may be fixedly arranged in the limiting part, and the magnet may be arranged outside the magnetic circuit range of the WPAN speaker.

In some embodiments, the speaker housing includes a grille, a speaker body, and a speaker bottom plate. The grille may be connected to the upper end of the speaker body. The sound outlet of the speaker may be oriented toward the grille. The limiting part may include an upper cavity disposed at the bottom of the speaker body and a lower cavity arranged on the bottom plate of the speaker.

In some embodiments, a button assembly is further included, which may be made of an elastic material. The speaker housing may define a button hole for mounting the button assembly. The button assembly may include a button and a connecting arm, and the speaker housing may include a connecting bump that operates in cooperation with the connecting arm. The button may be fixedly connected to the connecting bump through the connecting arm, and the button may be arranged in the button hole. The control circuit board may include a key switch that operates in cooperation with the button.

In some embodiments, the button assembly further includes a button lamp circuit board, which includes luminous lamp beads, and which is electrically connected to the control circuit board. The button lamp circuit board may be fixedly arranged on the button, and the button may be provided with a light-transmitting area, and the light emitted by the light-emitting lamp beads may be operative to pass through the light-transmitting area.

In some embodiments, the speaker body is provided with a positioning platform for installing the speaker housing, and the positioning platform defines a fixing hole allowing the loudspeaker to partially pass through.

In some embodiments, the control circuit board includes a through hole that allows the loudspeaker to partially pass through.

In some embodiments, the speaker housing is horn-shaped.

In some embodiments, a battery is further included for supplying power to the control circuit board, such as where the battery is a lithium polymer battery.

In some embodiments, a charging interface for charging the battery is arranged on the control circuit board, and a charging hole matched with the charging interface is defined in the speaker housing. In various embodiments, the speaker may include solar panels for independent charging when exposed to sunlight. In various configurations, outdoor charging with solar panels provides a power bank for the speaker and other electronics. In other embodiments, which may or may not include solar charging feature, the speaker may provide portable charging to other devices. This allows the speaker's battery to charge other devices, like phones or tablets, in a similar manner to a portable power bank.

In some embodiments, a silicone pad is further included, which is fixedly arranged on the bottom of the speaker housing.

In some further embodiments a magnetically attractable WPAN speaker may include the loudspeaker, the control circuit board electrically connected to the loudspeaker, the speaker housing that includes the speaker body, the speaker bottom plate and the limiting part, the battery and the magnet, as well as a microphone and/or a wireless charger. As described above, the limiting part may include an upper cavity provided at a bottom of the speaker body and a lower cavity provided at the speaker bottom plate, and the magnet may be fixedly arranged in the limiting part, and arranged outside a magnetic circuit range of the loudspeaker.

In some such embodiments, the microphone may be operatively disposed in the speaker housing and electrically connected to the control circuit board. For example, the speaker housing may define, or otherwise include a microphone grill, aligned with the microphone. Also, the control circuit board may mount, or otherwise include, the microphone, such that the speaker body microphone grill aligns with the microphone on the control circuit board.

In the same, or other, such embodiments, the battery electrically connected to, and configured for supplying power to, the control circuit board may be charged using a wireless charger electrically connected to, and configured for supplying power to charge, the battery. Such a wireless charger may include a power pick-up unit and a communications and control unit. For example, the power pick-up unit may be at least one wireless charging receiving coil, which may be disposed in the speaker bottom plate, and the communications and control unit may be a wireless charging receiving circuit board electrically connected to the battery and configured to regulate power to charge the battery. In accordance with some such embodiments, the magnet may be ring-shaped, or may be made up of a plurality of magnets arranged in a ring, and the wireless charging receiving coil may have a diameter less than an inside dimeter of the magnet ring, such that the coil is disposed in the speaker bottom plate, concentric with the magnet ring and aligned inside the magnet ring.

Other embodiments are also disclosed.

Compared with the related art, this disclosure may have the following beneficial effects. The disclosure can greatly improve the user's experience of using the speaker through the magnet arranged in the speaker housing, so that the user can place the speaker in different manners, as per their different needs. In contrast, traditional speakers can only be placed on a horizontal plane or a surface with a lower slope, the speaker provided by the present disclosure has better flexibility in use.

Additional objects, advantages and novel features of the technology will be set forth in part in the description which follows, and in part will become more apparent to those skilled in the art upon examination of the following, or may be learned from practice of the technology.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawings, in which:

FIG. 1 is a schematic diagram illustrating an example structure of a magnetically attractable short-range wireless personal area network (WPAN) (e.g., BLUETOOTH) speaker, according to some embodiments.

FIG. 2 is a schematic diagram illustrating an example structure of the magnetically attractable WPAN speaker, from another angle, according to some embodiments.

FIG. 3 is an exploded schematic diagram of the magnetically attractable WPAN speaker according to some embodiments.

FIG. 4 is an exploded schematic diagram of a magnetically attractable WPAN speaker, according to some further embodiments.

Reference numbers used in the accompanying drawings: 100 or 400, WPAN speaker; 1, speaker housing; 2, loudspeaker; 3, control circuit board; 4, magnet; 5, limiting part 11, grille; 12, speaker body; 13, speaker bottom plate; 120, positioning protrusion; 31, through hole; 131, circular boss; 132, annular positioning groove; 5, button assembly; 51, button; 52, connecting arm; 53, button lamp circuit board; 511, light transmission area; 6, battery; 32, button switch; 33, charging interface; 121, button hole; 122, charging hole; 7, dust plug; 8, silicone pad; 37, microphone; 9, wireless charger; 123, microphone grill; 91, wireless charging receiving coil; 92, wireless charging receiving circuit board; and, 42a-g, plurality of magnets.

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

Embodiments of the present short-range wireless personal area network (WPAN) (e.g., BLUETOOTH) speaker offers portability and surround sound but also easy connectivity, durability, flexibility, style and an ability to stick on any surface.

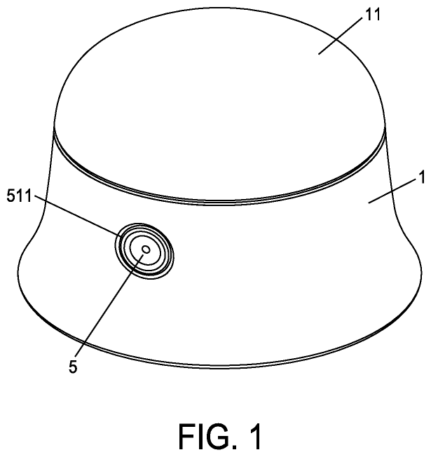

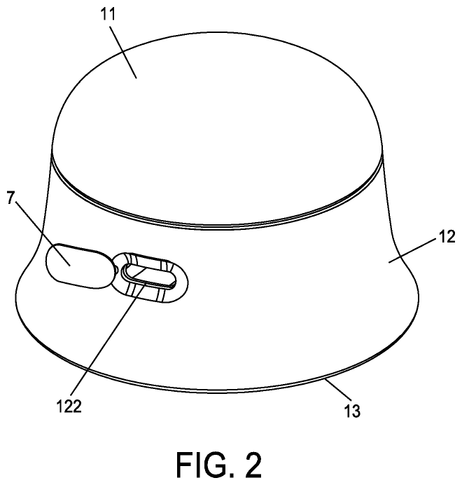

In an embodiment, as illustrated in FIGS. 1 through 3, magnetically attractable WPAN speaker 100 includes speaker housing 1, loudspeaker 2, control circuit board 3, and magnet 4. Loudspeaker 2 is electrically connected to control circuit board 3. Magnet 4 is, in accordance with various embodiments, arranged outside a magnetic circuit range of WPAN speaker 2. Speaker housing 1 includes limiting part 5 for securing magnet 4, which may be fixedly arranged in limiting part 5.

By arranging magnet 4 in speaker housing 1, the speaker can be used more flexibly and can be placed in any position. For example, when a tabletop is made of metal, the speaker can be attached to any place, including side panels, bottom panels, or sloped surfaces of the tabletop. When a tabletop is made of a non-metallic material, a metal material may be attached to the tabletop, and then the speaker may be magnetically attached to the metal material, which can also improve the flexibility of speaker placement. For example, embodiments of the present WPAN speaker can attach to any surface, by not only magnetizing itself to metals but also to other surfaces, such as wood, using adhesive metal rings that are included with the WPAN speaker. These adhesive metal rings may be carried, prior to such installation by being magnetically disposed on the base of the WPAN speaker. WPAN speaker 100 can also be attached to the back of a mobile phone to act as a stand for the mobile phone. For example, when the mobile phone is capable of magnetic attraction function, speaker 100 can be directly attached to the magnetic attraction part of the mobile phone. When the mobile phone has no magnetic attraction function, a metal material that matches the speaker may be attached to the back of the phone, and then the speaker may be attached to the metal material, magnetically. Thusly, the metal material may be used as the medium that attracts magnetically attractable WPAN speaker 100, which can flexibly meet the user's needs for use of the speaker. Thereby, compared with traditional ordinary speakers, that can only be placed on a horizontal plane or a surface with a low slope, the present magnetically attractable WPAN speaker provides better user experience.

In various embodiments, speaker housing 1 includes (dust cap) grille 11, speaker body 12, and speaker bottom plate 13. Grille 11 may be made of stainless steel. Speaker bottom plate 13 may be ultrasonically welded to speaker body 12. The lower end of grille 11 may be provided with a positioning groove. The upper end of speaker body 12 may be provided with positioning protrusion 120 that cooperates with the positioning groove at the lower end of grille 11. A fixed connection between grille 11 and speaker body 12 may be realized by snapping positioning protrusion 120 into the positioning groove.

Speaker body 12 may be provided with securing platform 3, which may be referred to as a fixing platform 3, and which may form at least a portion of control circuit board 3, for installing loudspeaker 2. Thereby, through hole 31 may be co-planer with control circuit board 3. Whereby, the sound outlet of loudspeaker 2 may be oriented toward grille 11. Also, securing platform 3 may be provided with a fixing hole allowing loudspeaker 2 to partially pass through. Layout of fixing hole 31 in the positioning platform allows loudspeaker 2 to have a certain fixing effect, so that loudspeaker 2 is not easily shaken during audio playback. Control circuit board 3 may be also provided with through hole 31, which, as noted, may be referred to as fixing platform 3, through which loudspeaker 2 passes. Use of through hole 31 leads to a higher utilization of the internal space of speaker housing 1.

Magnet 4 may, in accordance with dome embodiments, be a ring-shaped N52 neodymium iron boron magnet. The limiting part includes upper cavity 35 provided at the bottom of speaker body 12 and a lower cavity provided in speaker bottom plate 13. While, as noted, through hole 31 may be co-planer with control circuit board 3, in contrast, upper cavity 35 may extend beyond through hole 31. Both the upper cavity and lower cavity 36 each include a circular boss (131), provided in the center and an annular positioning groove (132) provided on the periphery of the circular boss. Magnet 4 may be arranged in annular positioning groove 132 of the upper cavity and the lower cavity.

By arranging magnet 4 between the bottom of speaker body 12 and speaker bottom plate 13, magnet 4 and loudspeaker 2 do not interfere with each other. Also, by arranging magnet 4 in annular positioning grooves 132 of the upper cavity and the lower cavity, a certain limit effect may be achieved to prevent WPAN speaker 100 from shaking during use. Thusly, magnet 4 adapts the neodymium iron boron magnet realizing more firm attraction so that WPAN speaker 100 will not easily move or fall.

Magnetically attractable WPAN speaker 100 may further include button assembly 5, and speaker housing 1 may be provided with button hole 121 for installing button assembly 5. Button assembly 5 makes WPAN speaker 100 more flexible to use, and the learning cost for use of the button is low. Button assembly 5 may include button 51, and connecting arm 52 arranged on each of both sides of button 51. Connecting arm 52 may be provided with a fixing hole, speaker body 12 may be provided with a positioning protrusion that operates in cooperation with the fixing hole in connecting arm 52. The positioning protrusion may be arranged in the fixing hole on connecting arm 52, and button 51 may be arranged in button hole 121 to achieve relative fixing between button assembly 5 and speaker body 12. Control circuit board 3 may be provided with button switch 32 that cooperates with button 51. In this example, button 51 may be made of an elastic plastic material, or the like. Through cooperation of connecting arms 52 and speaker body 12, button assembly 5 may be stably arranged on speaker body 12.

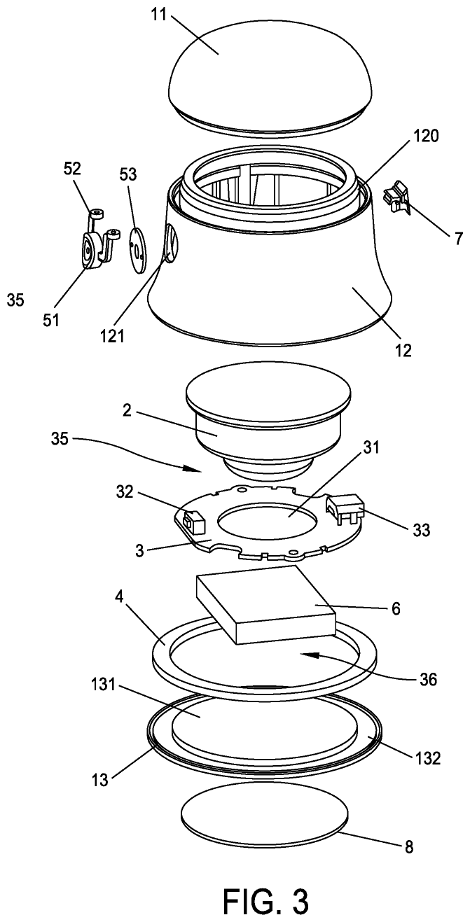

Button assembly 5 may further include button lamp circuit board 53, which is provided with light-emitting lamp beads (e.g., LEDs), or the like. Button lamp circuit board 53 may be electrically connected to control circuit board 3. Button lamp circuit board 53 may be fixedly arranged on and/or in (i.e., within, as shown in exploded FIG. 3) button 51. Button 51 may be provided with light-transmitting area 511 corresponding to the light-emitting lamp beads on button lamp circuit board 53. Through the arrangement of button lamp circuit board 53, the position of button 51 can be easily identified, even in a dark environment, which facilitates the operation of WPAN speaker 100 and which may play a certain reminder role with respect to use.

Speaker housing 1 may be horn-shaped, and this horn shape may facilitate WPAN speaker 100 fitting to the palm of the hand of a user more comfortably during holding and placement of the WPAN speaker.

Magnetically attractable WPAN speaker 100 may further include battery 6 for supplying power to control circuit board 3. Battery 6 may be a lithium polymer battery, or the like. For example, embodiments of the present WPAN speaker may house a lithium-ion battery, or the like, that fully charges after an hour and a half and provides up to eight hours of playtime. Control circuit board 3 may be provided with charging interface (port) 33 for charging battery 6, and speaker body 12 may be provided with charging hole 122 corresponding charging interface 33. Magnetically attractable WPAN speaker 100 may further include dust plug 7 adapted to be removably arranged on charging hole 122 for preventing debris from entering charging hole 122. Dust plug 7 may be tethered to speaker housing 1, for retention (e.g., to avoid loss) during charging, if accidently dislodged, or otherwise.

Magnetically attractable WPAN speaker 100 may further include silicone pad 8, which may be fixedly arranged at the bottom of speaker housing 1. The arrangement of silicone pad 8 prevents easy sliding of WPAN speaker 100, during placement or use, and to a certain extent, solves problems with respect to friction and scratching between WPAN speaker 100 and a countertop, or other surface the speaker is resting on or attracted onto. The size of silicone pad 8 may be the same as a size of circular boss 131 on speaker bottom plate 13. The sizes of silicone pad 8 and circular boss 131 are the same, so that the magnetic attraction capability of magnet 4 to metal is not affected, to the greatest extent.

As noted, embodiments of the present WPAN speaker may make use of short-range wireless personal area network protocols such as BLUETOOTH, IrDA, Wireless USB, ZIGBEE, or the like. For example, embodiments of the present WPAN speaker may employ (e.g., via control circuit board 3) BLUETOOTH 5.0 (or a newer version, including, but not limited to, BLUETOOTH 5.2, BLUETOOTH 5.3, BLUETOOTH 6, or a later version of BLUETOOTH), and works with any compatible BLUETOOTH device. This particular BLUETOOTH version features BLUETOOTH Low Energy (BLE), which reduces the energy usage of BLUETOOTH peripherals. With BLUETOOTH 5.0, all audio devices may communicate over BLE which means minimizing power usage and prolonging the devices' battery life. BLUETOOTH 5.0 also allows users to play audio simultaneously on two connected devices. Moreover, BLUETOOTH 5.0 features eight times the broadcasting message capacity, four times the range and two times the speed of older BLUETOOTH versions. Embodiments of the present WPAN speaker enables users to control the volume level of a paired BLUETOOTH device up to 30 feet away. The present magnetic WPAN speaker can also serve as an alarm clock using an alarm app on a paired device (e.g., a smartphone).

In accordance with the foregoing description of structure of magnetically attractable WPAN speaker 100, by arranging magnet 4 in speaker housing 1 as described, the user experience of the WPAN speaker can be greatly improved, so that the user can place it in different manners depending on their different needs. That is, compared with the traditional ordinary speakers that can only be placed on a horizontal plane or a surface with a small slope, WPAN speaker 100 provided by the present disclosure has better flexibility in use. For example, in the above-described embodiment(s), magnet 4 is a ring-shaped N52 neodymium iron boron magnet. Magnet 4 is arranged between the annular positioning groove at the bottom of speaker body 12 and annular positioning groove 132 of speaker bottom plate 13 to enable flexible placement of WPAN speaker 100, avoiding poor user experience. Other magnet configurations can also be used facilitate flexible placement of the WPAN speaker. For example, a magnet can be divided into four, or more, smaller magnets, which may be arranged, by way of example in accordance with the upper N, left S, lower N, and right S, and correspondingly the bottom of the speaker body and the speaker bottom plate can each be provided with magnet positioning grooves, or slots, matched with the four small magnets. Adopting this solution can also achieve the technical effects described above.

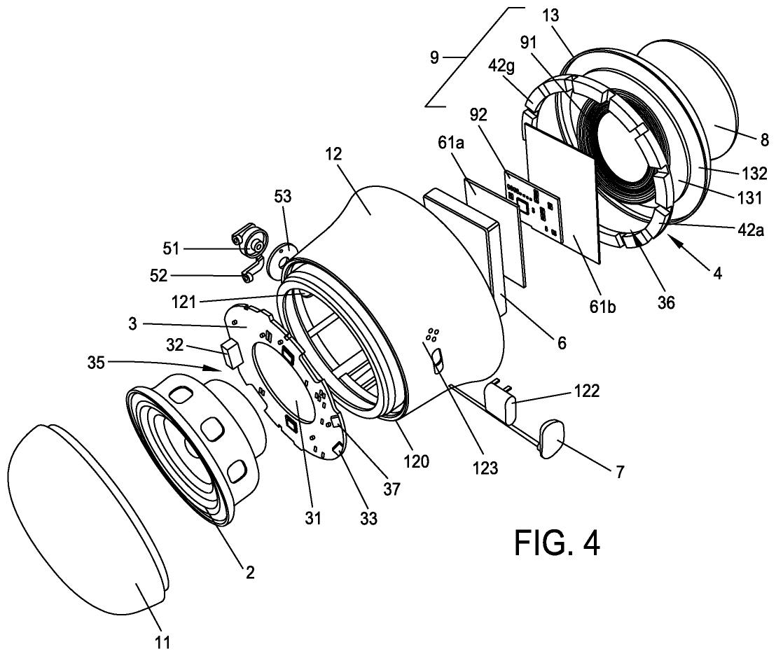

FIG. 4 is an exploded schematic diagram of magnetically attractable WPAN speaker 400, according to some further embodiments. In such further embodiments magnetically attractable WPAN speaker 400 may also include (horn-shaped) speaker housing 1, loudspeaker 2, control circuit board (PCB) 3, and magnet 4. as well as microphone 37 and/or wireless charger 9. As discussed above, loudspeaker 2 may be electrically connected to control circuit board 3. Magnet 4 may be arranged outside a magnetic circuit range of WPAN speaker 2. Speaker housing 1 includes limiting part 5 for securing magnet 4, which may be fixedly arranged in limiting part 5.

As also discussed above, by arranging magnet 4 in speaker housing 1, speaker 400 can be used more flexibly and can be placed in any position on metal or using adhesive metal rings that are included with WPAN speaker 400 and may be carried by being magnetically disposed on the base of the WPAN speaker. WPAN speaker 400 can also be attached to the back of a mobile phone to act as a stand for the mobile phone.

In various embodiments, housing 1 of WPAN speaker 400 also includes dust-free cap grille 11, (plastic) speaker body 12, and speaker bottom plate 13, and microphone 37 may be operatively disposed in speaker housing 1 and electrically connected to control circuit board 3. For example, speaker housing 1 may define, or otherwise include microphone grill 123, aligned with microphone 37. That is, in a further example, control circuit board 3 may mount, or otherwise include, microphone 37, as illustrated. Thereby, speaker body microphone grill 123 aligns with microphone 37 on control circuit board 3, in such embodiments.

As also discussed above, speaker bottom plate 13 may be ultrasonically welded to speaker body 12, or otherwise attached. Again, the lower end of grille 11 may have a positioning groove and the upper end of speaker body 12 may have positioning protrusion 120 that cooperates with the positioning groove at the lower end of grille 11, such that a grille 11 and speaker body 12 may be snap-fitted together by snapping the positioning protrusion into the positioning groove.

Again, speaker body 12 may be provided with securing platform 3, which may be referred to as a fixing platform 3, and which may form at least a portion of control circuit board 3, for installing loudspeaker 2. Thereby, through hole 31 may be co-planer with control circuit board 3. Whereby, the sound outlet of loudspeaker 2 may be oriented toward grille 11 and loudspeaker 2 may partially pass through hole 31.

As discussed above, too, magnet 4 may, in accordance with dome embodiments, be ring-shaped and the limiting part may include upper cavity 35 provided at the bottom of speaker body 12 and a lower cavity provided in speaker bottom plate 13. Both the upper cavity and the lower cavity 36 each include a circular boss (131), provided in the center and an annular positioning groove (132) provided on the periphery of the circular boss. Magnet 4 may be arranged in annular positioning groove 132 of the upper cavity and the lower cavity.

Magnetically attractable WPAN speaker 400 may also include battery 6 for supplying power to control circuit board 3. Again, battery 6 may be a lithium polymer battery, or the like. Also, control circuit board 3 may be provided with charging interface (USB type C port) 33 for charging battery 6, and speaker body 12 may be provided with charging hole 122 corresponding charging interface 33. Magnetically attractable WPAN speaker 100 may further include (tethered) dust plug 7. Also, in embodiments of magnetically attractable WPAN speaker 400 battery 6 may be charged using wireless charger 9 electrically connected to battery 6, and configured for supplying power to charge, battery 6, such as per the Qi wireless charging standard using inductive charging, or the like. Wireless charger 9 may include a power pick-up unit and a communications and control unit. For example, the power pick-up unit may be at least one wireless charging receiving coil 91, which may be disposed in speaker bottom plate 13, and the communications and control unit may be wireless charging receiving circuit board 92 electrically connected to battery 6 and configured to regulate power to charge battery 6. Wireless charging mechanisms may be configured to supply AC/DC or USB power to the battery and coil and printed circuit board (PCB). These wireless chagrining mechanisms may include, for example, magnetic inductive, near field radio frequency, RF chip and magnetic resonance charging mechanisms. Shockproof foam pads 61a and b may be arranged, such as in the manner illustrated, on either side of wireless charging receiving circuit board 92, to protect wireless charging receiving circuit board 92. As discussed above, magnet 4 may be ring-shaped, as shown in FIG. 3, or may be made up of a plurality of magnets 42a-n arranged in a ring, as shown in FIG. 4. In such embodiments, wireless charging receiving coil(s) 91 may also be ring-shaped, as illustrated, having a diameter less than an inside dimeter of magnet ring 4 or 42a-n, such that coil 91 is disposed in speaker bottom plate 131, such as inside annular positioning groove (132), on circular boss (131), concentric with magnet ring 4 or 42a-n, aligned inside magnet ring 4 or 42a-n. By arranging magnet 4 and wireless charging receiving coil(s) 91 between the bottom of speaker body 12 and speaker bottom plate 13, magnet 4 and/or wireless charging receiving coil(s) 91 do not interfere with loudspeaker 2.

As also discussed above, magnetically attractable WPAN speaker 400 may also have button assembly 5, and speaker housing 1 may have button hole 121 for installing button assembly 5. Button assembly 5 may, as noted, include button 51, and connecting arm 52 arranged on each of both sides of button 51 to provide relative fixing between button assembly 5 and speaker body 12. Control circuit board 3 may, as noted, be provided with button switch 32 that cooperates with button 51. As also described above, button assembly 5 may also include button lamp circuit board 53, with light-emitting lamp beads (e.g., LEDs), or the like. Button lamp circuit board 53 may be electrically connected to control circuit board 3 and be fixedly arranged on and/or in (i.e., within, as shown in exploded FIG. 4) button 51. Button light-transmitting area 511 may correspond to the LEDs to light button 5 to facilitate use.

Magnetically attractable WPAN speaker 400 may also include non-slip silicone pad or mat 8, which may be fixedly arranged at the bottom of speaker housing 1, such as to prevent sliding of, or marring by, WPAN speaker 400. The sizes of (concentric) silicone pad 8, circular boss 131, magnet 4 and/or wireless charging receiving coil(s) 91 may cooperate in such a way that the magnetic attraction capability of magnet 4 to metal, and the power pick-up ability of wireless charging receiving coil(s) 91, are not affected, to the greatest extent.

In accordance with various embodiments, the present WPAN speaker has a durable design to withstand the threats of the environment and other elements and conditions it is exposed to both indoor and outdoor. For example, embodiments of the present WPAN speaker feature IPX4 (ingress protection code 4 against harmful ingress of water) which means it can withstand water splashes from any direction, making it water-resistant, aside from being dust-proof, and may be made waterproof.

In accordance with the foregoing, even though various embodiments of the present WPAN speaker may be relatively small and compact, the present WPAN speaker may employ 360-degree surround sound. Embodiments of the present WPAN speaker may also feature a bass technology to deliver a distinctive listening experience to users. As noted, embodiments of the present WPAN speaker may employ wireless stereo pairing or the ability to connect two of the present WPAN speakers easily via a single device. This allows users to enjoy a definitive acoustic experience at the push of a button. Additionally, as noted, the present WPAN speaker's design enables it to be used as a kickstand on smartphones, tablets, or the like (e.g., magnetically attached to the back of a smartphone, tablet, or the like capable of magnetic attraction function, and used to support the device) for convenient gaming, music listening, movie streaming, audio books, podcasts, and webinars.

In various embodiment, the wireless charger may be integrated current carrying conductors into material of the speaker housing. The wireless charger may be configured to supply DC power to the speaker coil, battery and printed circuit board (PCB). The wireless charger may be configured to supply AC power to the electrical device. The wireless charger may be configured to supply DC power to the electrical device. The wireless charger may be configured to supply power to the speaker device. The wireless charger may be configured to supply magnetic inductive power to the speaker. The wireless charger may be configured to receive and supply near field radio frequency (RF) power to the speaker. The wireless charger may be configured to supply receive and supply radio frequency (RF) chip converted power to the speaker. The wireless charger may be configured to supply at least one of a battery and a set of batteries for closed loop charging power to the speaker. The wireless charger may be configured to receive and supply and convert infrared light into electronic chip power to the speaker. The wireless charger may be configured to receive and supply and convert light emitting diode LED to the power button and trim on the speaker. The wireless charger may harvest over-the-air energy from one or more WiFi signals or from RF (radio frequency) power within the environment of the platform. Power harvesting may entail receipt of radio wave energy via one or more coils or antennas and converting the recovered energy to an appropriate low-frequency AC or a DC signal for powering one or more electronic device. Conversion may include rectification and/or filtering. The charger may also use harvesting to supplement source power being derived from an AC source such as a wall outlet, or provide backup power in the event of a power brownout or blackout. Harvesting source power may be provided in parallel with AC and/or DC power.

In some embodiments, an LED grid may be integrated on the speaker surface. This LED may be configured to respond to music, display song titles, or can be customized with personal designs.

Gesture control may be provided with sensors. This allows a user to change the volume, skip songs, or pause music using simple hand gestures.

There may be provided voice assistant integration. This enables the speaker to work seamlessly with popular voice assistants so as to turn the speaker into a voice-controlled device.

Expandable sound capability is provided by multiple speakers. The speaker may be configured to connect wirelessly with other similar units. This allows users to “expand” their sound system on demand, thus, creating a surround sound experience.

In various embodiments, the speaker may be personalized. This includes customizable exteriors with different colors, textures, or designs that users may swap out to match their style or mood. In one embodiment, the speaker is adorned with licensed content (e.g., from Disney, Hasbro, Nickelodeon, and other various licensors.)

The speaker may be provided with various electronic control features. For example, environment sensing may be provided with embedded sensors that detect ambient noise. The speaker may be configured with this environment sensing to adjust volume or equalizer settings to best suit the surroundings. Another feature is a learning algorithm which may be integrated into the speaker. Using machine learning to understand a user's listening habits, the speaker may be configured to automatically play favorite music or suggest new tracks based on user preferences. Furthermore, built-in storage may be provided in which internal storage allows users to save playlists or songs. This configuration provides a standalone music player using the speaker without any need to connect to a device.

The speaker may be constructed with durable and eco-friendly materials. This construction may include materials that are tough, water-resistant, and environmentally friendly. Materials may include, for example, but are not limited to, bioplastics or recycled materials.

The speaker may be configured for use with an interactive app. In various embodiments, an app may be provided that offers an enhanced user experience. This may involve interaction regarding equalizer settings, creating light shows, sharing playlists, or even locating a misplaced speaker.

Sound direction control may be provided in which users may direct sound emanation. This feature directs sound towards the user regardless of where the speaker is placed.

As should be appreciated by the functionality of the speaker, there is an ability to operate as one or more of a baby monitor, an emergency weather radio, and a two-way radio communication device. Furthermore, the speaker may operate as part of an artificial intelligence (AI) interface to an AI system in which a user may respond to the AI system through the speaker.

In one or more embodiments, components may be added or removed. Upgradeable components may include various parts like the battery, speaker drivers, or connectivity modules without buying a whole new unit.

When elements are referred to as being “connected” “coupled,” or the like (e.g., electrically connected) the elements can be directly connected or coupled together or one or more intervening elements may also be present. In contrast, when elements are referred to as being “directly connected” or “directly coupled,” there are no intervening elements present. The terms “a” and “an” mean one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

The foregoing merely illustrates some illustrative embodiments of the present disclosure and are not intended to limit the present disclosure. Any modification, equivalent replacement, improvement, etc. made within the spirit and principle of the disclosure shall be included in the scope of protection of the disclosure. That is, although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. A magnetically attractable wireless personal area network (WPAN) speaker comprising:
a loudspeaker;
a control circuit board electrically connected to the loudspeaker;
a speaker housing comprising:
a speaker body;
a speaker bottom plate; and
a limiting part, the limiting part comprising an upper cavity provided at a bottom of the speaker body and a lower cavity provided at the speaker bottom plate;
a magnet fixedly arranged in the limiting part, and arranged outside a magnetic circuit range of the loudspeaker; and
a microphone operatively disposed in the speaker housing and electrically connected to the control circuit board.

2. The magnetically attractable WPAN speaker of claim 1, wherein the speaker housing further comprises a microphone grill, aligned with the microphone.

3. The magnetically attractable WPAN speaker of claim 1, wherein the control circuit board includes the microphone.

4. The magnetically attractable WPAN speaker of claim 3, wherein the speaker body further comprises a microphone grill, aligned with the microphone included on the control circuit board.

5. The magnetically attractable WPAN speaker of claim 1, further comprising:
a battery electrically connected to, and configured for supplying power to, the control circuit board; and
a wireless charger electrically connected to, and configured for supplying power to charge, the battery.

6. The magnetically attractable WPAN speaker of claim 5, wherein the wireless charger comprises:
a wireless charging receiving coil; and
a wireless charging receiving circuit board electrically connected to the wireless charging coils and the battery to charge the battery.

7. A magnetically attractable wireless personal area network (WPAN) speaker comprising:
a loudspeaker;
a control circuit board electrically connected to the loudspeaker; and
a speaker housing comprising:
a speaker body;
a speaker bottom plate; and
a limiting part, the limiting part comprising an upper cavity provided at a bottom of the speaker body and a lower cavity provided at the speaker bottom plate;
a magnet fixedly arranged in the limiting part, and arranged outside a magnetic circuit range of the loudspeaker;
a battery electrically connected to, and configured for supplying power to, the control circuit board; and
a wireless charger electrically connected to, and configured for supplying power to charge, the battery.

8. The magnetically attractable WPAN speaker of claim 7, wherein the wireless charger comprises a power pick-up unit and a communications and control unit.

9. The magnetically attractable WPAN speaker of claim 8, wherein:
the power pick-up unit comprises at least one wireless charging receiving coil; and
the communications and control unit comprises a wireless charging receiving circuit board electrically connected to the battery and configured to regulate power to charge the battery.

10. The magnetically attractable WPAN speaker of claim 9, wherein the wireless charging receiving coil is disposed in the speaker bottom plate.

11. The magnetically attractable WPAN speaker of claim 10, wherein the magnet is ring-shaped or comprises a plurality of magnets arranged in a ring, and the wireless charging receiving coil has a diameter less than an inside dimeter of the ring and is disposed in the speaker bottom plate concentric with the ring and aligned inside the ring.

12. The magnetically attractable WPAN speaker of claim 7, wherein the magnet is ring shaped or comprises a plurality of magnets arranged in a ring, and the magnetically attractable WPAN speaker further comprises:
a wireless charging receiving coil having a diameter less than an inside dimeter of the ring and is disposed in the speaker bottom plate inside the ring; and
comprises a wireless charging receiving circuit board electrically connected to the battery and configured to regulate power to charge the battery.

13. The magnetically attractable WPAN speaker of claim 7, further comprising a microphone operatively disposed in the speaker housing and electrically connected to the control circuit board.

14. The magnetically attractable WPAN speaker of claim 7, wherein the speaker housing further comprises a microphone grill, aligned with the microphone.

15. The magnetically attractable WPAN speaker of claim 14, wherein the control circuit board includes the microphone.

16. A magnetically attractable wireless personal area network (WPAN) speaker comprising:
a loudspeaker;
a control circuit board electrically connected to the loudspeaker; and
a battery electrically connected to, and configured for supplying power to, the control circuit board a speaker housing comprising:
a speaker body;
a speaker bottom plate; and
a limiting part, the limiting part comprising an upper cavity provided at a bottom of the speaker body and a lower cavity provided at the speaker bottom plate;
a magnet fixedly arranged in the limiting part, and arranged outside a magnetic circuit range of the loudspeaker;
a microphone operatively disposed in the speaker housing and electrically connected to the control circuit board; and
a wireless charger electrically connected to, and configured for supplying power to charge, the battery.

17. The magnetically attractable WPAN speaker of claim 16, wherein the speaker housing further comprises a microphone grill, aligned with the microphone.

18. The magnetically attractable WPAN speaker of claim 17, wherein the control circuit board includes the microphone.

19. The magnetically attractable WPAN speaker of claim 16, wherein the wireless charger comprises:
a wireless charging receiving coil; and
a wireless charging receiving circuit board electrically connected to the wireless charging coil and the battery to charge the battery.

20. The magnetically attractable WPAN speaker of claim 19, wherein the magnet is ring shaped or comprises a plurality of magnets arranged in a ring, and the wireless charging receiving coil has a diameter less than an inside dimeter of the ring and is disposed in the speaker bottom plate inside the ring.
